(19) United States
(12) Patent Application Publication
(10) Pub. No.: US 2022/0235428 A1
(43) Pub. Date: Jul. 28, 2022

(54) HEAT TREATMENT FURNACE, INFORMATION PROCESSING APPARATUS AND INFORMATION PROCESSING METHOD

(71) Applicant: KANTO YAKIN KOGYO CO., LTD., Hiratsuka-shi (JP)

(72) Inventors: Shinichi TAKAHASHI, Hiratsuka-shi (JP); Kiichi KANDA, Hiratsuka-shi (JP); Hiroshi OSHITA, Hiratsuka-shi (JP); Takashi NINOMIYA, Hiratsuka-shi (JP)

(21) Appl. No.: 17/717,651

(22) Filed: Apr. 11, 2022

Related U.S. Application Data
(63) Continuation of application No. PCT/JP2020/038406, filed on Oct. 9, 2020.

(30) Foreign Application Priority Data
Oct. 15, 2019 (JP) 2019-189015
Mar. 23, 2020 (JP) 2020-050417

(51) Int. Cl. C21D 1/76; C21D 1/06; C21D 11/00; C23C 8/22

(52) U.S. Cl. CPC C21D 1/76; C23C 8/22; C21D 11/00; C21D 1/06

(57) ABSTRACT

An object of the present disclosure is to make it possible to allow an operator or the like to grasp a carbon potential value of an atmosphere in a heat treatment furnace more simply. A heat treatment furnace (10) according to one aspect of the present disclosure includes a carbon potential value deriving section configured to derive a carbon potential value of an atmosphere in a heat treatment chamber on a basis of output of a gas sensor, and output of a temperature sensor, and a first display section configured to display the derived carbon potential value (P1) on a graph D that is displayed in a first display area (41A), and has a first axis representing carbon potential values, and a second axis representing temperatures and crossing the first axis.

### CROSS-REFERENCE TO RELATED APPLICATION

This application is a continuation of International Application No. PCT/JP2020/038406, filed Oct. 9, 2020 which claims the benefit of priority of the prior Japanese Patent Application No. 2019-189015, filed Oct. 15, 2019 and the benefit of priority of the prior Japanese Patent Application No. 2020-050417, filed Mar. 23, 2020. The contents of these applications are incorporated herein by reference in their entirety.

### TECHNICAL FIELD

The present disclosure relates to a heat treatment furnace, and particularly relates to a heat treatment furnace suitable for controlling the carbon potential value of the atmosphere in the heat treatment furnace, a control method therefor, an information processing apparatus, an information processing method, and a program.

### BACKGROUND ART

Conventionally, generation gases are used for heat treatment of steels. For example, by producing an RX gas by heat dissociation of a mixture gas of a hydrocarbon gas and air using a nickel (Ni) catalyst, supplying the RX gas to a heat treatment chamber as an atmosphere gas, and also adjusting the carbon potential (CP) value of the atmosphere to a predetermined value, a carburization process of a steel is possible (see the PATENT DOCUMENT 1, for example).

### PATENT DOCUMENTS

### [Patent Document 1]

Japanese Patent Laid-Open No. 2010-285642

### SUMMARY

### Technical Problem

Meanwhile, carbon potential values relate not only to carburization of steels, but also to decarburization of the steels. Accordingly, the mechanical properties and compositions of the steels after heat treatment can be freely manipulated by controlling the carbon potential value. In automated heat treatment furnaces that are used nowadays, the carbon potential value is adjusted by computer control. However, there are no problems in a case where the computer control is performed suitably, but, for example, in a case where there is a problem in the control, grasping whether or not the carbon potential value control is properly performed depends on the ability of an operator of a heat treatment furnace.

An object of the present disclosure is to make it possible to allow an operator or the like to grasp the carbon potential value of the atmosphere in a heat treatment furnace more simply.

### Solution to Problem

One aspect of the present disclosure for achieving the object described above provides a heat treatment furnace including a carbon potential value deriving section configured to derive a carbon potential value of an atmosphere in a heat treatment chamber on the basis of output of a gas sensor, and output of a temperature sensor, and a first display section configured to display the derived carbon potential value on a graph that is displayed in a first display area, and has a first axis representing carbon potential values, and a second axis representing temperatures and crossing the first axis.

Preferably, the carbon potential value deriving section derives the carbon potential value of the atmosphere in the heat treatment chamber on the basis of output of a CO sensor, output of a CO₂ sensor and the output of the temperature sensor. Alternatively, the carbon potential value deriving section can derive the carbon potential value of the atmosphere in the heat treatment chamber on the basis of output of a dew point sensor, output of a hydrogen sensor and the output of the temperature sensor. In addition, the carbon potential value deriving section may derive the carbon potential value of the atmosphere in the heat treatment chamber on the basis of output of an oxygen sensor and the output of the temperature sensor.

Preferably, the heat treatment furnace mentioned before can further include a target value deriving section configured to derive a carbon-potential-value target value of the atmosphere in the heat treatment chamber on the basis of a carbon content of a workpiece heat-treated in the heat treatment chamber. The first display section may further display, on the graph, the carbon-potential-value target value derived by the target value deriving section. Alternatively, the heat treatment furnace mentioned before may further include a target value input section through which a carbon-potential-value target value is input. In this case, the first display section may further display, on the graph, the target value input through the target value input section. The heat treatment furnace may include an adjustment gas supply system configured to supply an adjustment gas to the heat treatment chamber. In this case, the adjustment gas supply system may include a control section that controls supply of the adjustment gas such that the carbon potential value derived by the carbon potential value deriving section follows the target value.

Preferably, the heat treatment furnace described above further includes a standard-Gibbs-energy-of-formation deriving section configured to derive standard Gibbs energy of formation of an atmosphere gas in the heat treatment chamber on the basis of output of the gas sensor or a second gas sensor, and output of the temperature sensor or a second temperature sensor, and a second display section configured to display the derived standard Gibbs energy of formation on an Ellingham diagram that is displayed in a second display area, and is related to an oxide of a predetermined component of a workpiece heat-treated in the heat treatment chamber. The heat treatment furnace may further include a generation gas supply system configured to supply a generation gas produced by a generation gas producing apparatus to the heat treatment chamber as an atmosphere gas. In this case, the generation gas supply system may include a control section that controls actuation of the generation gas producing apparatus such that the derived standard Gibbs energy of formation is within a predetermined range.

Another aspect of the present disclosure also resides in a control method of a heat treatment furnace. The method may include deriving a carbon potential value of an atmosphere in a heat treatment chamber on the basis of output of a gas sensor, and output of a temperature sensor, displaying the derived carbon potential value, and a carbon-potential-value target value on a graph that is displayed in a first display area, and has a first axis representing carbon potential values, and a second axis representing temperatures and crossing the first axis, and controlling supply of an adjustment gas to the heat treatment chamber such that the derived carbon potential value follows the target value.

In addition, still another aspect of the present disclosure is represented also by, as an example, an information processing apparatus including a control section. The control section may execute deriving a carbon potential value of an atmosphere in a heat treatment chamber on the basis of output of a gas sensor, and output of a temperature sensor, and displaying the derived carbon potential value on a graph that is displayed in a first display area, and has a first axis representing carbon potential values, and a second axis representing temperatures and crossing the first axis. The control section may further execute deriving a carbon-potential-value target value of the atmosphere in the heat treatment chamber on the basis of a carbon content of a workpiece heat-treated in the heat treatment chamber. In this case, the control section may further execute displaying the derived carbon-potential-value target value on the graph. Alternatively, the control section may further execute displaying an input carbon-potential-value target value on the graph. The control section may further execute controlling supply of an adjustment gas from an adjustment gas supply system to the heat treatment chamber such that the derived carbon potential value follows the target value. The control section may further execute deriving standard Gibbs energy of formation of an atmosphere gas in the heat treatment chamber on the basis of output of the gas sensor or a second gas sensor, and output of the temperature sensor or a second temperature sensor, and displaying the derived standard Gibbs energy of formation on an Ellingham diagram that is displayed in a second display area, and is related to an oxide of a predetermined component of a workpiece heat-treated in the heat treatment chamber. In this case, the control section may further execute controlling actuation of a generation gas producing apparatus of a generation gas supply system configured to supply a generation gas to the heat treatment chamber as an atmosphere gas such that the derived standard Gibbs energy of formation is within a predetermined range.

Furthermore, another aspect of the present disclosure is represented also by, as an example, an information processing method in at least one computer such as the information processing apparatus including the control section mentioned before. In this information processing method, the at least one computer may execute deriving a carbon potential value of an atmosphere in a heat treatment chamber on the basis of output of a gas sensor, and output of a temperature sensor, and displaying the derived carbon potential value on a graph that is displayed in a first display area, and has a first axis representing carbon potential values, and a second axis representing temperatures and crossing the first axis. The at least one computer may further execute displaying, on the graph, a carbon-potential-value target value, of the atmosphere in the heat treatment chamber, derived on the basis of a carbon content of a workpiece heat-treated in the heat treatment chamber, or displaying an input carbon-potential-value target value on the graph.

Furthermore, in addition, still another aspect of the present disclosure is represented also by, as an example, a program that the at least one computer mentioned before is caused to execute. This program may cause the at least one computer to execute deriving a carbon potential value of an atmosphere in a heat treatment chamber on the basis of output of a gas sensor, and output of a temperature sensor, and displaying the derived carbon potential value on a graph that is displayed in a first display area, and has a first axis representing carbon potential values, and a second axis representing temperatures and crossing the first axis. The at least one computer may be caused to further execute displaying, on the graph, a carbon-potential-value target value, of the atmosphere in the heat treatment chamber, derived on the basis of a carbon content of a workpiece heat-treated in the heat treatment chamber, or displaying an input carbon-potential-value target value on the graph.

### Advantageous Effect of Invention

According to the aspects of the present disclosure that are described above, because they include the configurations described above, it becomes possible to allow an operator or the like to grasp the carbon potential value of the atmosphere in a heat treatment furnace more simply.

### BRIEF DESCRIPTION OF DRAWINGS

FIG. 1 is a schematic configuration diagram of a heat treatment furnace according to one embodiment of the present disclosure.

FIG. 2 is an explanatory figure of the display of a second display area in the heat treatment furnace in FIG. 1.

FIG. 3 is an explanatory figure of the display of a first display area in the heat treatment furnace in FIG. 1.

FIG. 4 is a flowchart of control related to the carbon potential value in the heat treatment furnace in FIG. 1.

FIG. 5 is a functional block diagram of a control apparatus as an information processing apparatus in the heat treatment furnace in FIG. 1.

FIG. 6 is a functional block diagram of a modification example of the control apparatus as the information processing apparatus.

FIG. 7 is a figure for explaining a modification example of the graph in FIG. 3.

FIG. 8 is a figure for explaining another modification example of the graph in FIG. 3.

### DESCRIPTION OF EMBODIMENT

An embodiment according to the present disclosure represents, as examples, a heat treatment furnace, a control method therefor, an information processing apparatus, an information processing method, and a program. The information processing apparatus can be provided in a heat treatment furnace. A control section included in the information processing apparatus executes deriving the carbon potential (CP) value (hereinafter, the CP value) of the atmosphere in a heat treatment chamber on the basis of the output of a gas sensor, and the output of a temperature sensor, and displaying the derived CP value on a graph that is displayed in a first display area, and has a first axis representing CP values, and a second axis representing temperatures and crossing the first axis. Furthermore, the control section further executes deriving a CP-value target value of the atmosphere in the heat treatment chamber on the basis of the carbon content of a workpiece heat-treated in the heat treatment chamber. Then, the control section further executes displaying the derived CP-value target value on the graph. The control section may further execute displaying an input CP-value target value on the graph. The control section further executes controlling supply of an adjustment gas from an adjustment gas supply system to the heat treatment chamber such that the derived CP value follows the target value.

The control section included in the information processing apparatus executes acquiring the output of the gas sensor, and the output of the temperature sensor. Then, on the basis of the output, the control section executes deriving the CP value of the atmosphere in the heat treatment chamber. The gas sensor can be one or more of a CO sensor, a CO₂ sensor, a dew point sensor, a hydrogen sensor, and an oxygen sensor. The derived CP value is displayed on the graph that is displayed in the first display area, and has the first axis representing CP values, and the second axis representing temperatures and crossing the first axis. Furthermore, the control section further executes deriving a CP-value target value of the atmosphere in the heat treatment chamber on the basis of the carbon content of the workpiece heat-treated in the heat treatment chamber. The CP-value target value is not limited to a derived value, but may be a value input by an operator of the heat treatment furnace or the like. Then, the control section further executes displaying the CP-value target value on the graph mentioned before. In this manner, the CP value of the atmosphere in the heat treatment chamber is derived, and displayed on the graph in the display area. Accordingly, it is possible to allow an operator or the like to grasp the CP value of the atmosphere in the heat treatment furnace more simply.

Hereinafter, an embodiment according to the present disclosure is explained on the basis of the attached figures. Identical components (or configurations) are given identical reference characters, and their names and functions are also the same. Accordingly, detailed explanations thereof are not repeated.

A heat treatment furnace 10 according to one embodiment of the present disclosure is configured to heat-treat a workpiece in an atmosphere gas. The material of the workpiece can be a steel for carburization such as S09CK, S15CK, or S20CK (see JIS) typically in a case where a carburization process is performed, but may be another steel or the like. For example, the material of the workpiece may be a low carbon steel for mechanical structure having a small carbon content or may be an alloy steel for mechanical structure. The heat treatment furnace 10 according to the one embodiment of the present disclosure can be used also for typical heat treatment which is not performed for the purpose of a carburization process or a decarburization process. In an example explained here, as mentioned later, assuming that the material of the workpiece is S45C (having a carbon concentration of 0.42% by mass to 0.48% by mass) in the JIS standards, heat treatment (e.g. normalizing, annealing, quenching, tempering) of S45C is performed in the heat treatment furnace 10. However, the present disclosure, specifically the heat treatment furnace 10, can be applied also to carburization and decarburization processes.

The heat treatment furnace 10 includes a heat treatment chamber 12 for heat-treating a workpiece, and a system that supplies a generated carrier gas (hereinafter, generation gas supply system) 14 configured to supply a carrier gas, that is, a generation gas, generated as an atmosphere gas. The generation gas supply system 14 is configured to cause a reaction between air and a hydrocarbon gas as a fuel by mixing them at a predetermined ratio, and produce the generation gas. Particularly, here, a generation gas producing apparatus 16 of the generation gas supply system 14 is actuated to produce an endothermic RX gas as the generation gas. The generation gas producing apparatus 16 can be what is called a generating furnace. It should be noted, however, that the generation gas supplied from the generation gas supply system 14 may be a gas other than an RX gas.

The RX gas is an example of an endothermic gas containing carbon monoxide (CO). The RX gas can be produced by using, as a raw material gas, a hydrocarbon gas such as a propane (C₃H₈) gas or a butane (C₄H₁₀) gas, and causing heat dissociation of the hydrocarbon gas by using an Ni catalyst in a state that the hydrocarbon gas and air are mixed at a predetermined ratio. The produced RX gas contains carbon monoxide (CO), hydrogen (H₂), nitrogen (N₂), carbon dioxide (CO₂) and the like as components. Then, the RX gas is introduced into the heat treatment chamber 12 of the heat treatment furnace 10 as the atmosphere gas. For example, at the time of a carburization process, an equilibrium reaction called the Boudouard reaction which is “2CO↔(C)+CO₂” is caused on the surface of a steel which is a workpiece. That is, at the time of carburization, CO in the RX gas, which is the atmosphere gas in the heat treatment furnace, supplies carbon (C) to the surface of the workpiece, and the carbon is suctionally attracted to the surface of the steel, and then diffused to the inside of the steel. It should be noted, however, that (C) in the formula mentioned before is C of a solid solution C in γ iron. On the other hand, hydrogen in the RX gas has an extremely strong reduction power, and reacts with oxygen to produce water vapor. The produced water vapor can cause decarburization. In order to adjust such carburization or decarburization, an adjustment gas can be supplied in the manner explained below. Note that, in carburization/decarburization processes of a steel, a predetermined amount of the RX gas is constantly introduced into the heat treatment chamber, and also a corresponding amount of a gas in the furnace is released to the outside of the furnace as an exhaust gas, although an explanation of this is omitted because it is a known matter.

The heat treatment furnace 10 further includes an adjustment gas supply system 18 configured to supply the adjustment gas to the heat treatment chamber 12. The adjustment gas supply system 18 has a reduction gas supply apparatus 20 and an enriching gas supply apparatus 22. Here, the reduction gas supply apparatus 20 has a first valve 26 provided on a path that connects a reduction gas tank 24 to the heat treatment chamber 12. Here, the enriching gas supply apparatus 22 has a second valve 30 provided on a path that connects an enriching gas tank 28 to the heat treatment chamber 12. Whereas the reduction gas is air here, it may be a gas other than air, and, for example, can be various gases such as a nitrogen (N₂) gas that, when supplied, bring about a reduction of the carbon concentration of the atmosphere gas. The enriching gas may be a hydrocarbon gas, and, for example, may be a propane (C₃H₈) gas or a butane (C₄H₁₀) gas. For example, the enriching gas can be various gases that, when supplied, bring about an increase of the carbon concentration of the atmosphere gas, and a methane (CH₄) gas, an acetylene (C₂H₂) gas, and the like are not excluded from examples thereof.

In addition, in order to sense the gas components and temperature of the atmosphere gas in the heat treatment chamber 12, the heat treatment furnace 10 includes various types of gas sensors 32, 34, and 36 and a temperature sensor 38. Examples of the gas sensors can include an oxygen (O₂) sensor 32, a CO sensor 34, and a CO₂ sensor 36. Note that it is also possible to omit some gas sensors in the gas sensors and to further include another gas sensor such as a dew point sensor. The CO sensor 34 and the CO₂ sensor 36 are not particularly limited, but here are sensors that analyze and measure, by infrared spectroscopy, a partial atmosphere gas taken in by a gas sampling apparatus. The atmosphere gas having been used for the analysis is discharged as an analysis exhaust gas.

The output from each of the sensors 32, 34, 36 and 38 is input to a control apparatus 40 that serves the function as a control section. The control apparatus 40 is configured as what is called a computer, and includes a processing section (e.g. a CPU) which is what is called a processor, a storage section (e.g. a ROM and a RAM), and input/output ports. On the basis of the output from them, the control apparatus 40 can control actuation of the generation gas producing apparatus 16 of the generation gas supply system 14. In addition, the control apparatus 40 is connected to the first valve 26 of the reduction gas supply apparatus 20, and the second valve 30 of the enriching gas supply apparatus 22, and can control actuation of the valves 26 and 30 on the basis of the output of the sensors described above. Accordingly, the control apparatus 40 has the function as a control section of the generation gas supply system 14, and the function as a control section of the adjustment gas supply system 18. Note that the control apparatus 40 includes an input apparatus and a display apparatus 41. For example, the input apparatus is a keyboard and a mouse. The display apparatus 41 is a monitor.

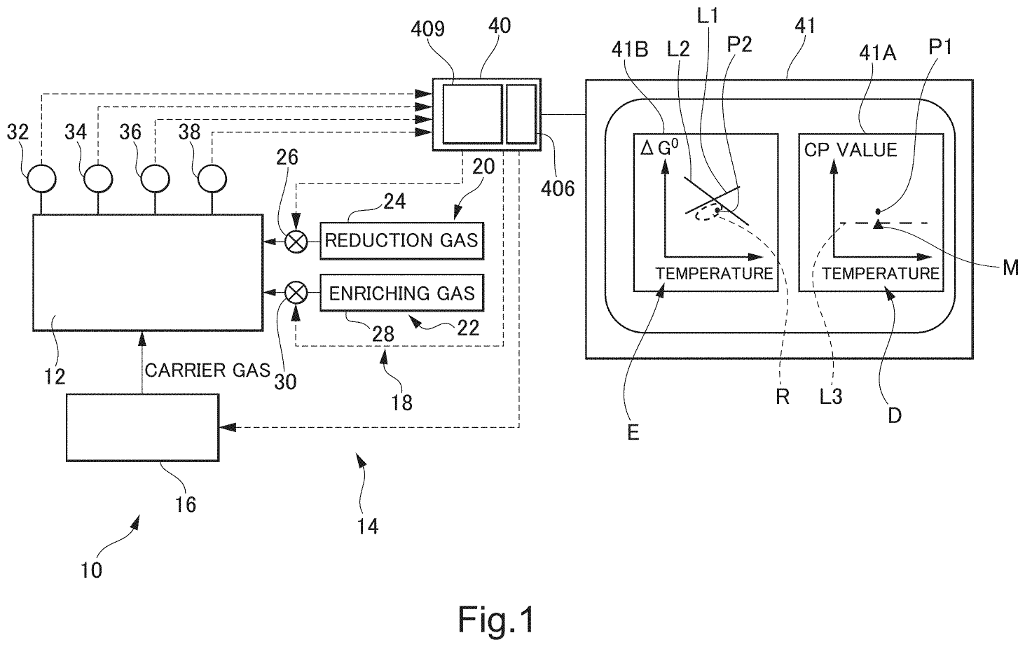

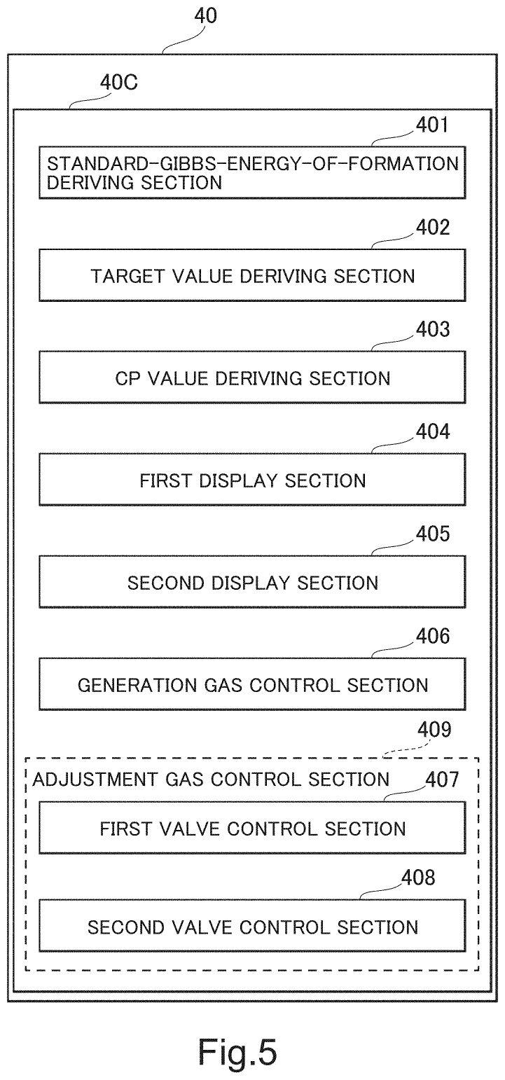

In the present embodiment, the control apparatus 40 performs control of the atmosphere gas so as to substantially prevent decarburization and carburization of a workpiece from being caused in heat treatment of the workpiece. A program and data for this are stored on the control apparatus 40. In the control apparatus 40, a processing section 40C that substantially serves the function as a control section executes a program stored on a storage section to thereby realize various types of functional modules. Specifically, as the functional modules, the control apparatus 40 has a standard-Gibbs-energy-of-formation deriving section 401, a target value deriving section 402, a carbon potential value deriving section (hereinafter, CP value deriving section) 403, a first display section 404, a second display section 405, a generation gas control section 406, a first valve control section 407, and a second valve control section 408. The first and second valve control sections 407 and 408 are included in an adjustment gas control section 409 as a functional module. FIG. 5 depicts a functional block diagram of the processing section 40C, that is, a control section, of the control apparatus 40. Note that FIG. 1 depicts the functional modules 406 and 409 which are part of the functional modules. Some of the functional modules may be hardware such as other processors, digital circuits, or analog circuits.

In the present embodiment, on the basis of the output of the oxygen sensor 32 and the output of the temperature sensor 38, the standard-Gibbs-energy-of-formation deriving section 401 derives (that is, calculates) the standard Gibbs energy of formation (ΔG⁰) of the atmosphere gas in the heat treatment chamber 12, i.e. the atmosphere gas in the furnace. Specifically, the standard-Gibbs-energy-of-formation deriving section 401 can calculate ΔG⁰ on the basis of an oxygen partial pressure and the absolute temperature by using Formula (1). Note that P(O₂) is the oxygen partial pressure, T is the absolute temperature, and R is a gas constant.

ΔG⁰=RTlnP(O₂) (1)

Note that the standard-Gibbs-energy-of-formation deriving section 401 may derive ΔG⁰ by using another calculation formula or the like on the basis of the output of another gas sensor such as the CO sensor 34 or the CO₂ sensor 36.

Then, the generation gas control section 406 controls actuation of the generation gas producing apparatus 16 such that ΔG⁰ derived by the standard-Gibbs-energy-of-formation deriving section 401 is within a predetermined range. The generation gas control section 406 is equivalent to the control section of the generation gas supply system 14. Here, in accordance with a predetermined program or the like, the generation gas control section 406 controls components of the raw material gas of the generation gas in the generation gas producing apparatus 16, that is, controls the mixing ratio of the fuel and air. The predetermined range is a range R on an Ellingham diagram in a second display area 41B of the display apparatus 41 in FIG. 1, and can be specified in accordance with a workpiece, as the details are mentioned later.

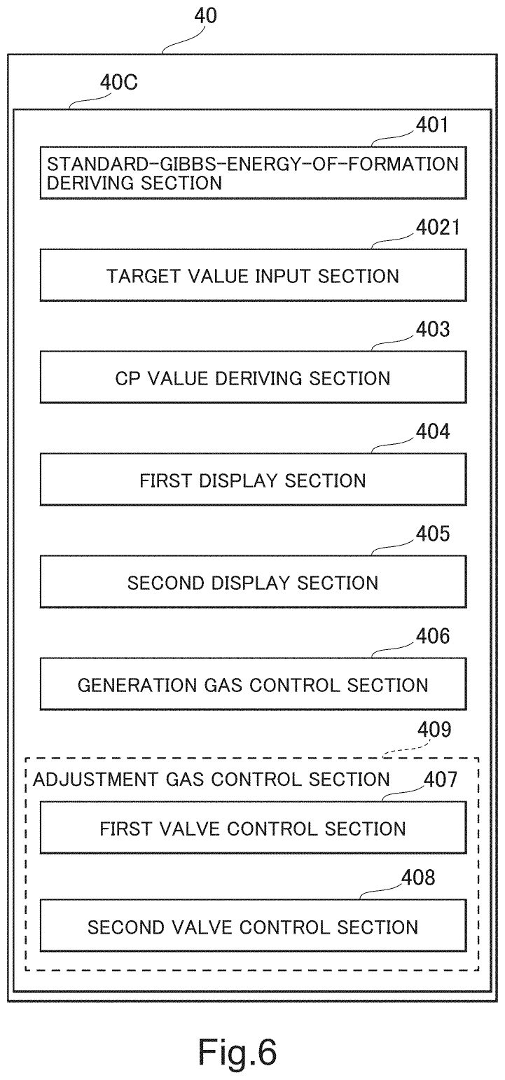

The target value deriving section 402 derives a CP-value target value of the atmosphere in the heat treatment chamber 12, that is, the atmosphere in the system, i.e. in the furnace. In accordance with a workpiece heat-treated in the heat treatment chamber 12, the target value deriving section 402 derives the CP-value target value corresponding to the workpiece. More specifically, on the basis of the carbon content of the workpiece heat-treated in the heat treatment chamber 12, the target value deriving section 402 derives the CP-value target value of the atmosphere in the heat treatment chamber 12. Accordingly, the target value deriving section 402 has a storage section that can be part of the storage section described above, calculation formulae and data are stored on the storage section, an operator inputs the material of the workpiece, the carbon content of the workpiece, and the like, and the target value is derived thereby. Examples of the data can include a carbon content database related to materials, for example. Here, because the material of the workpiece is S45C as mentioned already, 0.45% is derived as the CP-value target value that substantially prevents decarburization and carburization from being caused to the workpiece. For example, in a case where decarburization or carburization is to be caused to the workpiece, the target value deriving section 402 may derive a CP-value target value according to the decarburization or carburization. That is, CP-value target values may be set in accordance with components of workpieces, types of heat treatment performed in the heat treatment furnace 10 (e.g. normalizing, annealing, quenching, tempering, decarburization, and carburization), components of the atmosphere gas, and/or the like. Note that the target values are not limited to values derived by the target value deriving section 402, but, for example, may be values themselves that are directly input by an operator or the like. For example, the control apparatus 40 may have, as a functional module, a target value input section 4021 (see FIG. 6) through which a CP-value target value is input by an operator inputting a CP-value target value to the input apparatus, and it may be possible to process, as a target value as is, the target value input to the target value input section. The control apparatus 40 may have both the target value deriving section 402 and the target value input section 4021 as functional modules.

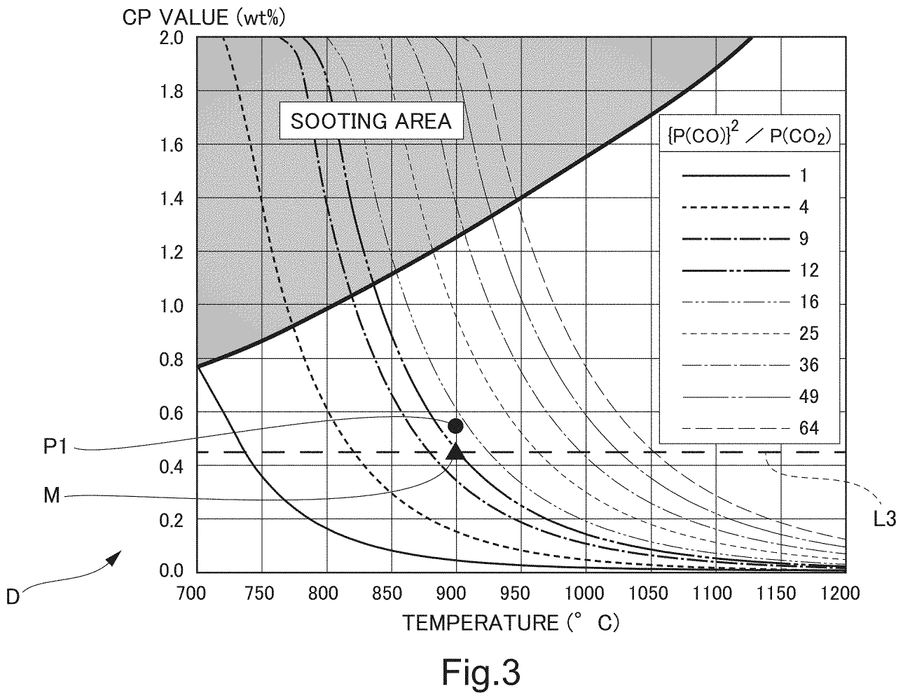

A CP value deriving section 403 derives the CP value of the atmosphere in the heat treatment chamber 12. In the present embodiment, the CP value deriving section 403 derives the CP value of the atmosphere in the heat treatment chamber 12 on the basis of the output of each of the CO sensor 34 and the CO₂ sensor 36, and the output of the temperature sensor 38. A detailed explanation of a method of deriving a CP value in the present embodiment is described below. Note that a unit of the CP value is expressed in wt % in FIG. 3, but may be expressed in mass %.

There is a chemical equilibrium represented by the following Formula (2) between solid-state carbon, carbon dioxide, and carbon monoxide.

(C)+CO₂═2CO (2)

This equilibrium relationship is called the Boudouard equilibrium, and (C) in Formula (2) is a solid solution C in γ iron, for example.

Then, the CP value can be derived on the basis of the following Formula (3). Here, K is the equilibrium constant of Formula (2) described above, P(CO) is a carbon monoxide partial pressure (atm), P(CO₂) is a carbon dioxide partial pressure (atm), and a_{c} is the activity of carbon.

K═{P(CO)}²/[P(CO₂)·a_{c}] (3)

Then, regarding a carbon steel for mechanical structure in steels, the activity a_{c} of carbon can be represented by the following Formula (4). It should be noted, however, that Ac is the content (%) of carbon melted in austenite, and As is the saturated carbon content (%) of austenite. It should be noted, however, that because As is determined on the basis of a temperature in accordance with an Fe—C system state diagram, the storage section of the control apparatus 40 has data equivalent to the Fe—C system state diagram stored thereon. Note that carbon steels for mechanical structure are defined in JIS G SG4051 of the JIS standards, for example.

a_{c}═Ac/As (4)

Here, Ac, which is the content (%) of carbon melted in austenite, is equivalent to the CP value. Accordingly, Ac, that is, the CP value, can be derived by performing a calculation on the basis of Formula (2) to Formula (4) on the basis of the output of each of the CO sensor 34 and the CO₂ sensor 36, and the output of the temperature sensor 38.

Note that the CP value deriving section 403 may derive the CP value by using other calculation formulae or the like on the basis of the output of another gas sensor like an oxygen (O₂) sensor or a dew point sensor, for example.

For example, the CP value may be derived in accordance with Formula (2) described above and the following relational expressions by using a dew point sensor and a hydrogen sensor instead of the CO sensor 34 and the CO₂ sensor 36.

As a water gas reaction (reverse shift reaction), the relationship of the following Formula (5) holds true.

CO₂+H₂═CO+H₂O (5)

The following Formula (6) can be derived from the relationship between Formula (2) described above and Formula (5).

(C)+H₂O═CO+H₂ (6)

When Formula (6) is in the equilibrium state, the following Formula (7) holds true. It should be noted, however, that K₂ is the equilibrium constant of Formula (6), P(CO) is a carbon monoxide partial pressure (atm) as described above, P(H₂) is a hydrogen partial pressure (atm), and can be determined on the basis of the output of the hydrogen sensor, P(H₂O) is an H₂O partial pressure (atm), and can be determined on the basis of the output of the dew point sensor, and a_{c} is the activity of carbon as mentioned above.

K₂═[P(CO)·P(H₂)]/[a_{c}·P(H₂O)] (7)

Here, supposing P(CO) remains constant (i.e. is a constant) because changes of the CO concentration in the atmosphere in the furnace are typically very small, the CP value can be derived by performing a calculation on the basis of the output of the dew point sensor as a gas sensor, the output of the hydrogen sensor as a gas sensor, and the output of the temperature sensor. Note that the CP value may be derived more accurately by further using the CO sensor, and determining P(CO) accurately.

In addition, for example, the CP value may be calculated in accordance with Formula (2) described above and the following relational expressions by using an oxygen sensor instead of the CO sensor 34 and the CO₂ sensor 36.

The relationship of the following Formula (8) holds true as a reaction in the furnace at the time of decarburization or carburization.

CO₂═CO+1/2O₂ (8)

The following Formula (9) can be derived from the relationship between Formula (2) described above and Formula (8).

(C)+1/2O₂═CO (9)

When Formula (9) is in the equilibrium state, the following Formula (10) holds true. It should be noted, however, that K₃ is the equilibrium constant of Formula (9), P(CO) is a carbon monoxide partial pressure (atm) as described above, P(O₂) is an oxygen partial pressure (atm), and can be determined on the basis of the output of the oxygen sensor, and a_{c} is the activity of carbon as mentioned above.

K₃═P(CO)/[a_{c}·{P(O₂)}^{1/2}] (10)

Here, supposing P(CO) remains constant (i.e. is a constant) because changes of the CO concentration in the atmosphere in the furnace are typically very small, the CP value can be derived by performing a calculation on the basis of the output of the oxygen sensor and the output of the temperature sensor. Note that the CP value may be derived more accurately by further using the CO sensor and determining P(CO) accurately.

Completely different sensors may be used as sensors for deriving ΔG⁰ and as sensors for deriving the CP value. For example, a temperature sensor for sensing a temperature for calculating the CP value may be a temperature sensor provided separately from a temperature sensor for sensing a temperature for calculating AGO. This applies also to gas sensors similarly.

The first valve control section 407 and the second valve control section 408 control the first valve 26 and the second valve 30 so as to adjust the CP value of the atmosphere in the heat treatment chamber 12. The first valve control section 407 controls actuation of the first valve 26 of the reduction gas supply apparatus 20. The second valve control section 408 controls actuation of the second valve 30 of the enriching gas supply apparatus 22. Here, these first and second valve control sections 407 and 408 are substantially one control section, are equivalent to the control section of the adjustment gas supply system 18, that is, the adjustment gas control section 409, and are actuated so as to adjust the CP value of the atmosphere in the heat treatment chamber 12. Here, as mentioned later, the first and second valve control sections 407 and 408 control the supply of a reduction gas and an enriching gas as adjustment gases such that the CP value derived by the CP value deriving section 403 follows the target value described above. Note that, by increasing the degree of opening of the first valve 26 of the reduction gas supply apparatus 20, the carbon concentration of the atmosphere gas, specifically the CO concentration, decreases, and the CP value lowers. On the other hand, by increasing the degree of opening of the second valve 30 of the enriching gas supply apparatus 22, the carbon concentration of the atmosphere gas increases, and the CP value rises.

The first display section 404 displays a derived CP value in a first display area 41A of the display apparatus 41. The second display section 405 displays derived standard Gibbs energy of formation in the second display area 41B of the display apparatus 41.

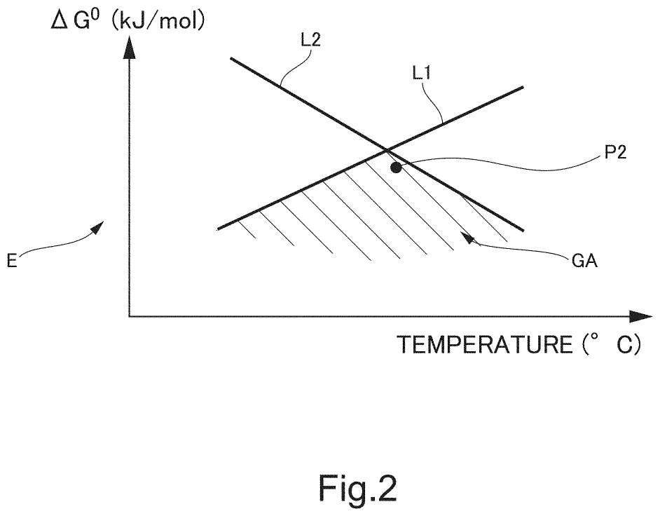

First, the display of the second display area 41B of the display apparatus 41 is explained on the basis of FIG. 1 and FIG. 2. The second display area 41B displays an Ellingham diagram E related to the standard Gibbs energy of formation of an oxide of a predetermined component of a workpiece. Ellingham diagrams are graphs having a horizontal axis representing temperatures, and a vertical axis representing Gibbs energy of formation, and standard Gibbs energy of formation (ΔG⁰) of various oxides at each temperature is plotted on the Ellingham diagrams. Because the material of the workpiece is S45C here, approximation lines L1 and L2 related to an oxide of iron and an oxide of carbon are displayed on the Ellingham diagram E in the second display area 41B. The line L1 in the Ellingham diagram E in FIG. 1 and FIG. 2 is an approximation straight line of the standard Gibbs energy of formation of iron (Fe) and iron oxide (FeO), and the line L2 is an approximation straight line of the standard Gibbs energy of formation in the reaction of 2C+O₂═2CO. A program or the like is defined such that, when a workpiece W is a steel material, ΔG⁰ of the atmosphere gas in the heat treatment chamber 12 during heat treatment is within an area GA below both the line L1 and the line L2 in the graph in FIG. 2. Because the area GA is a reduction area of iron, and is also a reduction area of carbon, by performing control such that ΔG⁰ of the atmosphere gas is within the area GA, shortcomings of oxidation or decarburization of the workpiece during heat treatment are not caused. Here, particularly, the program or the like is defined such that ΔG⁰ of the atmosphere gas is within a predetermined range R (see FIG. 1) which is a particular area that is in the area GA, and furthermore near the lines L1 and L2. In accordance with the component of the workpiece, the line L1 or a line that is specified further in addition to the line L1 can be made a straight line of an oxide corresponding to the component. Because of this, the control apparatus 40 can store data of various oxides, and specify one or more oxides after receiving operation on the input apparatus. Note that the predetermined range R may be set in accordance with components of workpieces, types of heat treatment performed in the heat treatment furnace 10 (e.g. normalizing, annealing, quenching, tempering, decarburization, and carburization), components of the atmosphere gas, and/or the like.

The second display section 405 displays (see FIG. 1 and FIG. 2) a plotted point P2 of derived standard Gibbs energy of formation on the Ellingham diagram E described above in the second display area 41B of the display apparatus 41. By looking at the plotted point P2, an operator or the like can visually grasp a state of the standard Gibbs energy of formation ΔG⁰ of the atmosphere gas easily. In addition, because the predetermined range R is also displayed on the Ellingham diagram E of the second display area 41B as depicted in FIG. 1, the operator or the like can visually grasp whether or not the standard Gibbs energy of formation ΔG⁰ at each moment is an appropriate value more simply.

Next, the display of the first display area 41A of the display apparatus 41 is explained on the basis of FIG. 1 and FIG. 3. The first display area 41A displays a graph D of CP values. The graph D is a graph having a vertical axis as a first axis representing CP values, and a horizontal axis as a second axis crossing the first axis and representing temperatures. On this graph D, the plotted point P1 of a derived CP value can be displayed in relation to a temperature at that time. Furthermore, on this graph D, a derived target value is also displayed, and here a line L3 equivalent to the target value is displayed on the graph D. Note that, because the saturated carbon content As of austenite can change in accordance with temperatures, the CP value is displayed in relation to the temperatures. Here, a mark M is further displayed as a target value for the same temperature.

The first display section 404 displays (see FIG. 1 and FIG. 3) the plotted point P1 of the derived CP value on the graph D described above in the first display area 41A of the display apparatus 41. By looking at this plotted point P1, the operator or the like can visually grasp the CP value easily. Particularly, here, the derived target value is also displayed on the graph D. Accordingly, the operator or the like can visually grasp the CP value more simply. Note that, as is apparent from the explanation mentioned before, the target value displayed on the graph D may be a target value input to the target value input section.

Control of the atmosphere gas in the heat treatment furnace 10 with the configuration described above is explained further. Note that, in an example explained here, as mentioned already, assuming that the material of the workpiece is S45C (having a carbon concentration of 0.42% by mass to 0.48% by mass) in the JIS standards, heat treatment of S45C is performed in the heat treatment furnace 10.

First, the operator inputs “S45C” as the material of the workpiece through the input apparatus, and selects desired heat treatment. Thereby, the mixing ratio of air and the fuel of the raw material gas in the generation gas producing apparatus 16 of the generation gas supply system 14 is determined, and thereby the control apparatus 40 actuates the generation gas producing apparatus 16. Here, the generation gas producing apparatus 16 produces an RX gas containing a desired component, specifically an RX gas containing a predetermined amount of a CO gas, and the RX gas is supplied to the heat treatment chamber 12.

The standard Gibbs energy of formation ΔG⁰ and the CP value are derived as mentioned above in a state that the RX gas is being supplied as the atmosphere gas. The plotted points P2 and P1 of these derived values are displayed on the corresponding graphs E and D in the display areas 41B and 41A, respectively, as depicted in FIG. 1, for example. Along with the display of the plotted point P1 of the CP value on the graph D displayed in the first display area 41A, the graph D also displays the line L3 of the derived CP-value target value.

The mixing ratio of air and the fuel of the raw material gas in the generation gas producing apparatus 16 is controlled on the basis of a predetermined program and data such that the plotted point P2 of the standard Gibbs energy of formation ΔG⁰ is within the predetermined range R of the Ellingham diagram E in FIG. 1. Thereby, it is possible to prevent oxidation and decarburization from being caused to the workpiece.

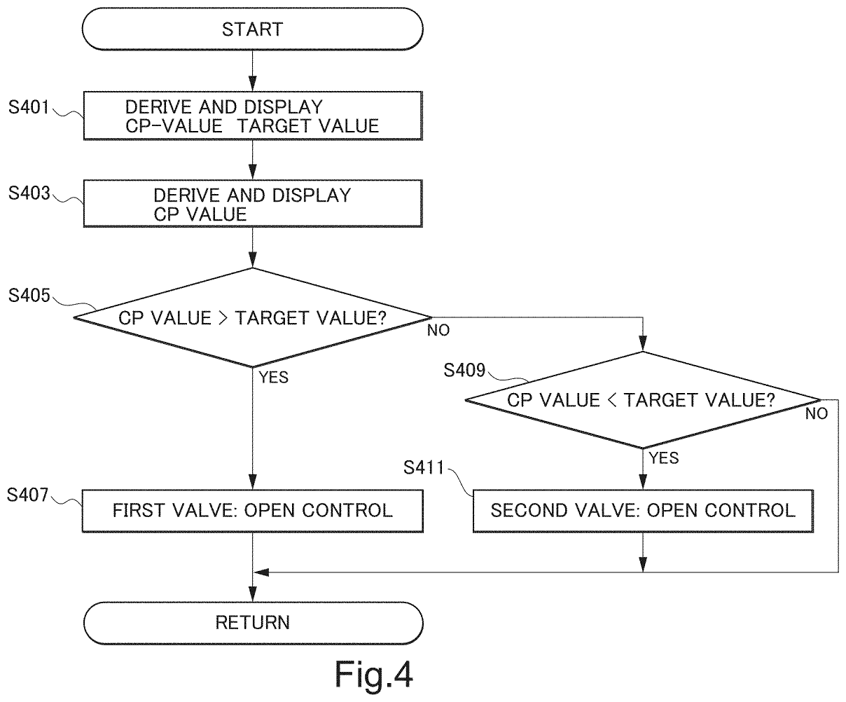

Furthermore, control based on the CP value is explained on the basis of the flowchart in FIG. 4. Note that the control can be feedback control that causes the derived CP value to follow the derived CP-value target value, but may be other control.

In the control based on the CP value depicted in FIG. 4, first, the CP-value target value is derived and displayed on the graph D as mentioned above (Step S401 in FIG. 4). In addition, the CP value is derived and displayed as mentioned above (Step S403 in FIG. 4). Then, the degree of opening of the first valve 26 and the degree of opening of the second valve 30 are controlled, and the flow rate of the adjustment gas is controlled such that the CP value, that is, the plotted point P1, follows the target value “0.45,” that is, the line L3.

At Step S405 in FIG. 4, the CP value derived at Step S403 is compared with the CP-value target value derived at Step S401. When the derived CP value is larger than the CP-value target value, the result of the decision at Step S405 is YES. At this time, at Step S407, the first valve 26 is controlled to open such that the CP value follows the CP-value target value. Here, the second valve 30 is closed at this time, but may be controlled to open such that the degree of opening of the second valve 30 becomes a predetermined degree of opening according to the degree of opening of the first valve 26. Thereby, the routine ends, and the next routine is repeated.

When the result of the decision at Step S405 in FIG. 4 is NO because the CP value is not larger than the CP-value target value, it is decided whether or not the CP value derived at Step S409 is smaller than the CP-value target value. When the result of the decision at Step S409 is YES because the CP value is smaller than the CP-value target value, at Step S411, the second valve 30 is controlled to open such that the CP value follows the CP-value target value. Here, the first valve 26 is closed at this time, but may be controlled to open such that the degree of opening of the first valve 26 becomes a predetermined degree of opening according to the degree of opening of the second valve 30. Thereby, the routine ends, and the next routine is repeated. Note that, even when the result of the decision at Step S409 is NO, the routine ends, and the next routine is repeated. When the result of the decision at Step S409 is NO, the first valve 26 and the second valve 30 are closed, but predetermined open control may be executed.

Note that, at Step S401 in the next routine, even in a case where the CP-value target value has not changed, the mark M is displayed at a target value according to a temperature at that time.

Here, as mentioned already, the target value is a theoretical value that causes neither decarburization nor carburization. Accordingly, by controlling the valves 26 and 30, the CP value is adjusted to a value by which the carbon concentration of the workpiece, and the carbon concentration on its surface become almost equal. This routine in FIG. 4 is repeated during heat treatment of the workpiece, and the CP value of the atmosphere in the heat treatment chamber 12 is kept in a suitable state.

In this manner, the workpiece is heat-treated in an environment where the atmosphere gas of the heat treatment chamber 12 is controlled. Then, in information processing at the control apparatus 40, the plotted point P1 of the CP value at each moment is displayed on the graph D in the first display area 41A of the display apparatus 41. Thereby, visualization of the CP value during heat treatment becomes possible, and it becomes possible to allow an operator or the like to grasp the CP value of the atmosphere in the heat treatment furnace more simply. Furthermore, the line L3 of the CP-value target value is also displayed on the graph D. Accordingly, it becomes possible to allow an operator or the like to grasp the CP value of the atmosphere in the heat treatment furnace still more simply. Particularly, because the plotted point P1 of the CP value is displayed on the graph D having the temperature axis, it becomes possible to grasp the CP value according to changes of the temperature of the atmosphere gas more suitably.

In addition, the predetermined range R, which is a target range, and the plotted point P2 of ΔG⁰ at each moment are displayed on the Ellingham diagram E of the second display area 41B of the display apparatus 41. Accordingly, the operator or the like can grasp the state of the atmosphere gas during heat treatment easily. That is, it becomes possible to allow the operator or the like to grasp ΔG⁰ and the CP value of the atmosphere in the heat treatment chamber 12 of the heat treatment furnace 10 more simply. Particularly, because the plotted point P2 of ΔG⁰ is displayed on the Ellingham diagram E having the temperature axis, it becomes possible to grasp ΔG⁰ according to changes of the temperature of the atmosphere gas more suitably.

Note that, whereas the first display area 41A and the second display area 41B on the display apparatus 41 are displayed next to each other in FIG. 1, they may be displayed in a switching manner. That is, the screen of the display apparatus 41 may be switched such that the second display area 41B is not displayed when the first display area 41A is displayed, and the first display area 41A is not displayed when the second display area 41B is displayed. In addition, there may be separate displays for the first display area 41A and the second display area 41B. Furthermore, the present disclosure permits the integrated display of the graph D in the first display area 41A, and the Ellingham diagram E in the second display area 41B. That is, the first display area 41A and the second display area 41B may be the same.

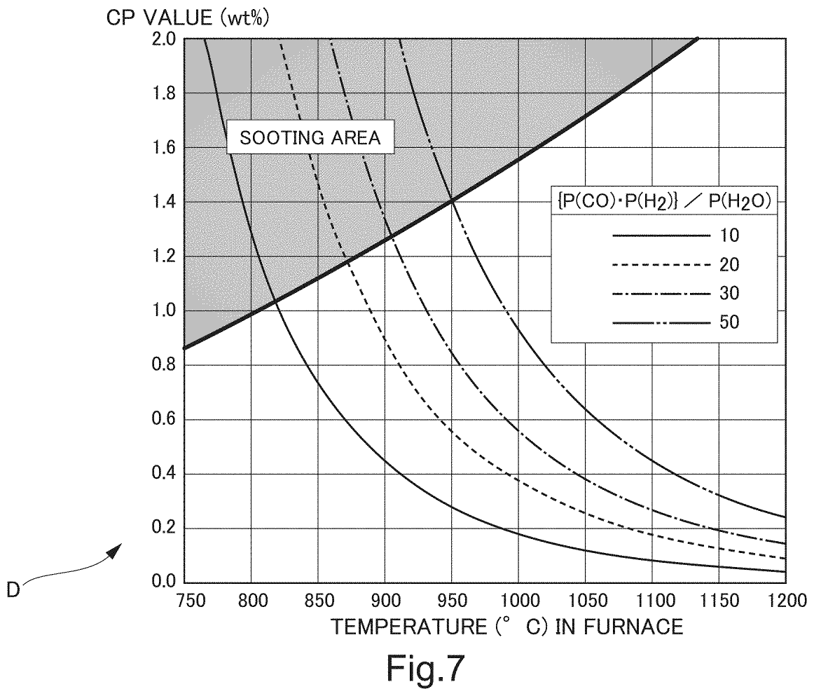

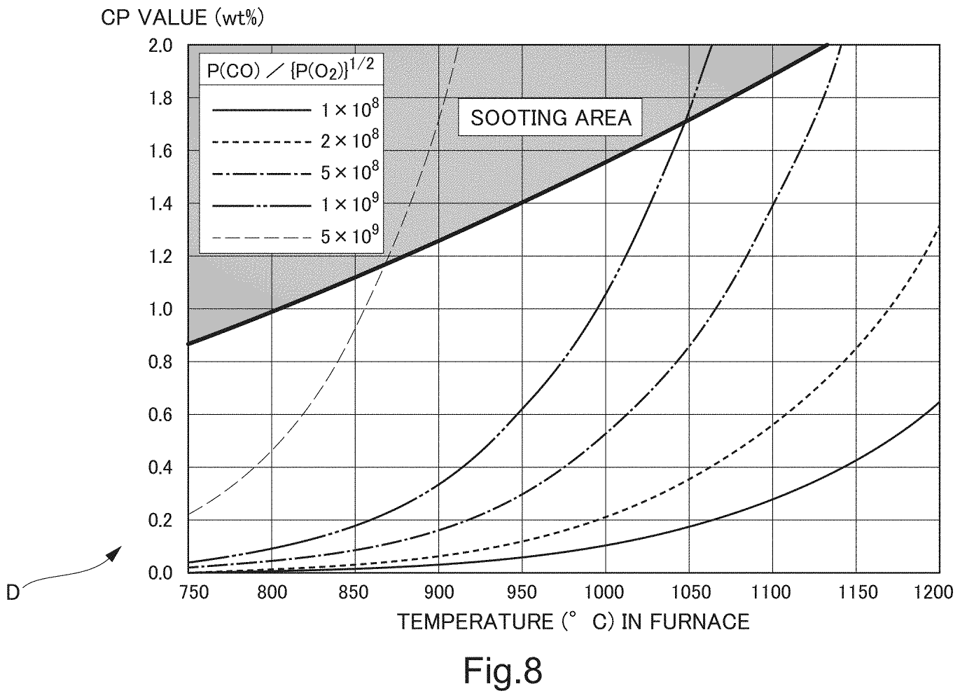

In addition, the display of the first display area 41A of the display apparatus 41 is not limited to the one in FIG. 3. Whereas the graph D of CP values is a graph having a vertical axis as the first axis representing CP values and having a horizontal axis as the second axis crossing the first axis and representing temperatures, auxiliary lines or the like displayed on the graph may be changed in accordance with a method of deriving the CP value. Specifically, curves as auxiliary lines in FIG. 3 are lines of “{P(CO)}²/P(CO₂)” for the same values. These lines are displayed for reference in the present embodiment because the CP value of the atmosphere in the heat treatment chamber 12 is derived on the basis of the output of each of the CO sensor 34 and the CO₂ sensor 36, and the output of the temperature sensor 38. As explained already, for example, when the CP value is derived on the basis of the output of each of the dew point sensor and the hydrogen sensor, and the output of the temperature sensor, the line of “[P(CO)·P(H₂)]/P(H₂O)” in Formula (7) may be displayed on the graph equivalent to FIG. 3 as depicted in FIG. 7. Similarly, for example, when the CP value is derived on the basis of the output of the oxygen sensor, and the output of the temperature sensor, the line of “P(CO)/{P(O₂)}^{1/2}” in Formula (10) may be displayed on the graph equivalent to FIG. 3 as depicted in FIG. 8. Note that the derived CP value, and the CP-value target value are omitted in FIG. 7 and FIG. 8.

Whereas an embodiment and modification examples thereof according to the present disclosure have been explained thus far, the present disclosure is not limited to them. Various replacements and changes are possible as long as such replacements and changes do not deviate from the spirit and scope of the present disclosure defined by claims of the present application. Processes and means explained in the present disclosure can be implemented by being combined with each other freely as long as such combinations do not cause technical contradictions.

For example, processes explained as being performed by one apparatus may be executed by being shared by a plurality of apparatuses. For example, the control apparatus 40, which is an information processing apparatus, needs not be one computer, but may be configured as a system including a plurality of computers. Alternatively, there are no problems even if processes explained as being performed by different apparatuses are executed by one apparatus. The type of hardware configuration to realize each function in a computer system can be changed flexibly. For example, the control apparatus 40 can be realized by supplying a computer with a computer program to implement the functions explained in the embodiment described above, and reading out and executing the program with one or more processors that the computer has. Such a computer program may be provided to a computer by being stored on a non-transitory computer-readable storage medium that can be connected to a system bus of the computer, or may be provided to the computer via a network. For example, the non-transitory computer-readable storage medium includes any type of disc such as a magnetic disc (floppy (registered trademark) disc, a hard disk drive (HDD), etc.) or an optical disc (a CD-ROM, a DVD disc, a Blue-ray disc, etc.), a read-only memory (ROM), a random access memory (RAM), an EPROM, an EEPROM, a magnetic card, a flash memory, an optical card, and any type of medium suitable for storing electronic instructions.

In addition, a processing section of the control apparatus 40 described above may be a CPU, but is not limited to a single processor, and may have a multi-processor configuration. In addition, a single CPU connected by a single socket may have a multi-core configuration. Processes to be performed by at least some of the sections described above may be performed by a processor other than a CPU, for example, by a dedicated processor such as a Digital Signal Processor (DSP) or a Graphics Processing Unit (GPU). In addition, processes to be performed by at least some of the sections described above may be an integrated circuit (IC) or another digital circuit. In addition, at least some of the sections described above may include analog circuits.

1. A heat treatment furnace comprising:
a carbon potential value deriving section configured to derive a carbon potential value of an atmosphere in a heat treatment chamber on a basis of output of a gas sensor, and output of a temperature sensor; and
a first display section configured to display the derived carbon potential value on a graph that is displayed in a first display area, and has a first axis representing carbon potential values, and a second axis representing temperatures and crossing the first axis.

2. The heat treatment furnace according to claim 1, wherein the carbon potential value deriving section derives the carbon potential value of the atmosphere in the heat treatment chamber on a basis of output of a CO sensor, output of a CO₂ sensor, and the output of the temperature sensor.

3. The heat treatment furnace according to claim 1, wherein the carbon potential value deriving section derives the carbon potential value of the atmosphere in the heat treatment chamber on a basis of output of a dew point sensor, output of a hydrogen sensor, and the output of the temperature sensor.

4. The heat treatment furnace according to claim 1, wherein the carbon potential value deriving section derives the carbon potential value of the atmosphere in the heat treatment chamber on a basis of output of an oxygen sensor and the output of the temperature sensor.

5. The heat treatment furnace according to claim 1, further comprising:
a target value deriving section configured to derive a carbon-potential-value target value of the atmosphere in the heat treatment chamber on a basis of a carbon content of a workpiece heat-treated in the heat treatment chamber.

6. The heat treatment furnace according to claim 5, wherein the first display section further displays, on the graph, the carbon-potential-value target value derived by the target value deriving section.

7. The heat treatment furnace according to claim 1, further comprising:
a target value input section through which a carbon-potential-value target value is input, wherein
the first display section further displays, on the graph, the target value input through the target value input section.

8. The heat treatment furnace according to claim 5, comprising:
an adjustment gas supply system configured to supply an adjustment gas to the heat treatment chamber, wherein
the adjustment gas supply system includes a control section that controls supply of the adjustment gas such that the carbon potential value derived by the carbon potential value deriving section follows the target value.

9. The heat treatment furnace according to claim 7, comprising:
an adjustment gas supply system configured to supply an adjustment gas to the heat treatment chamber, wherein
the adjustment gas supply system includes a control section that controls supply of the adjustment gas such that the carbon potential value derived by the carbon potential value deriving section follows the target value.

10. The heat treatment furnace according to claim 1, further comprising:
a standard-Gibbs-energy-of-formation deriving section configured to derive standard Gibbs energy of formation of an atmosphere gas in the heat treatment chamber on a basis of output of the gas sensor or a second gas sensor, and output of the temperature sensor or a second temperature sensor; and
a second display section configured to display the derived standard Gibbs energy of formation on an Ellingham diagram that is displayed in a second display area, and is related to an oxide of a predetermined component of a workpiece heat-treated in the heat treatment chamber.

11. The heat treatment furnace according to claim 10, further comprising:
a generation gas supply system configured to supply a generation gas produced by a generation gas producing apparatus to the heat treatment chamber as an atmosphere gas, wherein
the generation gas supply system includes a control section that controls actuation of the generation gas producing apparatus such that the derived standard Gibbs energy of formation is within a predetermined range.

12. An information processing apparatus comprising:
a control section that executes
deriving a carbon potential value of an atmosphere in a heat treatment chamber on a basis of output of a gas sensor, and output of a temperature sensor, and
displaying the derived carbon potential value on a graph that is displayed in a first display area, and has a first axis representing carbon potential values, and a second axis representing temperatures and crossing the first axis.

13. The information processing apparatus according to claim 12, wherein the control section further executes displaying, on the graph, a carbon-potential-value target value, of the atmosphere in the heat treatment chamber, derived on a basis of a carbon content of a workpiece heat-treated in the heat treatment chamber, or displaying an input carbon-potential-value target value on the graph.

14. The information processing apparatus according to claim 13, wherein the control section further executes controlling supply of an adjustment gas from an adjustment gas supply system to the heat treatment chamber such that the derived carbon potential value follows the target value.

15. The information processing apparatus according to claim 12, wherein
the control section further executes
deriving standard Gibbs energy of formation of an atmosphere gas in the heat treatment chamber on a basis of output of the gas sensor or a second gas sensor, and output of the temperature sensor or a second temperature sensor,
displaying the derived standard Gibbs energy of formation on an Ellingham diagram that is displayed in a second display area, and is related to an oxide of a predetermined component of a workpiece heat-treated in the heat treatment chamber, and
controlling actuation of a generation gas producing apparatus of a generation gas supply system configured to supply a generation gas to the heat treatment chamber as an atmosphere gas such that the derived standard Gibbs energy of formation is within a predetermined range.

16. An information processing method, wherein
at least one computer executes
deriving a carbon potential value of an atmosphere in a heat treatment chamber on a basis of output of a gas sensor, and output of a temperature sensor, and
displaying the derived carbon potential value on a graph that is displayed in a first display area, and has a first axis representing carbon potential values, and a second axis representing temperatures and crossing the first axis.

17. The information processing method according to claim 16, wherein the at least one computer further executes displaying, on the graph, a carbon-potential-value target value, of the atmosphere in the heat treatment chamber, derived on a basis of a carbon content of a workpiece heat-treated in the heat treatment chamber, or displaying an input carbon-potential-value target value on the graph.

18. The information processing method according to claim 16, wherein the at least one computer further executes
displaying the derived carbon potential value, and a carbon-potential-value target value on the graph that is displayed in the first display area; and
controlling supply of an adjustment gas to the heat treatment chamber such that the derived carbon potential value follows the target value.
